(19) United States
(12) Patent Application Publication
(10) Pub. No.: US 2026/0187052 A1
(43) Pub. Date: Jul. 2, 2026

(54) BUFFERED DATA MERGE PROCESSES IN DATABASE PLATFORMS

(71) Applicant: Zeta Global Corp., New York, NY (US)

(72) Inventor: Sekhar Sahu, San Francisco, CA (US)

(21) Appl. No.: 19/437,113

(22) Filed: Dec. 30, 2025

Related U.S. Application Data
(60) Provisional application No. 63/740,221, filed on Dec. 30, 2024.

(51) Int. Cl. G06F 16/23; G06F 7/14; G06F 16/2453

(52) U.S. Cl. CPC G06F 16/2393; G06F 7/14; G06F 16/2358; G06F 16/24539

(57) ABSTRACT

The subject technology includes a merge optimization system that may improve the efficiency of data merge processes. The merge optimization system may be integrated into a database platform that stores large datasets. The merge optimization system may generate a buffer table that stores changed data for one or more master tables in the database platform. The merge optimization system may generate a unified view based on the buffer table. The unified view may be materialized so that one or more clients connected to the database platform may query on an updated version of the master table in the unified view. Metadata generated by the merge optimization system may be monitored for one or more merge conditions. The merge conditions may trigger a merge process that updates the master table by writing the changed data in the buffer table to the master table.

### PRIORITY CLAIM

This patent application claims the benefit of priority, under 35 U.S.C. Section 119(e), to Sahu, U.S. Provisional Patent Application Serial Number 63/740,221, entitled “BUFFERED DATA MERGE PROCESSES IN DATABASE PLATFORMS,” filed on December 30, 2024 (Attorney Docket No. 4525.215PRV), which is hereby incorporated by reference in its entirety.

### TECHNICAL FIELD

The present disclosure relates generally to the technical field of databases and, more specifically, relates to techniques for merging external data into existing tables stored on cloud database platforms.

### BACKGROUND

Existing data merge processes for external data in cloud database platforms are copy-on-write methods, which require entire data files to be rewritten every time changed data added to an existing data table. Even small updates to existing data tables (e.g., updates to 10% of less of the tables rows) require the entire tables to be completely rewritten. The copy-on-write approach is slow, inefficient, and resource intensive. These deficiencies are amplified by data redundancy processes that rewrite and store multiple copies of each updated version of the data tables each time a data merge process is executed.

The inventors here have recognized several technical problems with such conventional methods and systems for merging external data in database platforms. These technical problems include the reduced performance and increased cost of cloud database platforms when running merge operations. Rewriting each table stored in a data warehouse for every external data merge, even merges that only change a small number of rows in the table, is inefficient and consumes more bandwidth, processing power, and electricity per unit of changed data other more optimized operations (e.g., queries, new table writes, and the like) that run on the database platforms. The increased resource consumption leads to longer processing times and higher costs for merge operations. Additionally, copy-on-write methods are in-compatible with workflows running in large scale data warehouses that require frequent updates to data and benefit from real-time or near real-time access to updated data. The inefficiency, long processing times, and high costs of existing merge processes make it impractical to execute workflows that require low data latency at scale, limiting the utility existing database platforms and the types of data driven applications available to users.

### SUMMARY

Embodiments of the present disclosure present technological improvements as solutions to one or more of the above-mentioned technical problems recognized by the inventors in conventional database platforms. For example, the merge optimization system improves the performance of database platforms by enabling more efficient data merge processes. The merge optimization system enables the database platforms to run data merge processes that are buffer based and merge-on-read. The merge optimization system improves merge processes by storing changed data in a buffer table and generating a unified view that combines the data in the buffer table with the original data in the master table. The unified view may be materialized to make the combination of the changed and master data available to query and use in real-time. One or more merge conditions (e.g., buffer table size, query performance on the unified view, and the like) may be determined and tracked over time by the merge optimization system as more data is added to the buffer table. The merge optimization system determines an optimal time to merge the data in the buffer table into the master table based on the merge conditions. The merge conditions may be tunable to tailor the merge optimizations provided by the merge optimization system for specific database platforms, datasets, and applications querying on the data.

The buffer based, merge-on-read techniques provided by the merge optimization system improves the functionality of database platforms by reducing the execution times and amount of processing resources (e.g., processing power, bandwidth, electricity, etc.) required to run merge operations. Additionally, the merge optimization system optimizes database platforms for workflows that require real-time or near real-time access to changed data in order to make low data latency workflows practical to implement and enable new applications that use real-time or near real-time data. For example, applications querying on data stored in database platforms included in the merge optimization system may obtain real-time or near-real time consumer events data. Applications such as, for example, a bidding component of an online ad exchange, may use the rapidly merged events data in order to, increase the resolution of bidstream data by resolving additional identifiers in ad placement metadata or determine the value of bids for ad placements to submit to the exchange. Other components of an online publication system may also use the rapidly merged events data by, for example, using the real time events data to run inference on one or more machine learning models that may identify additional identifiers to include in a target audience, recommend serving content to additional ad placements, and/or more accurately determining attribution rates for previous impressions.

### BRIEF DESCRIPTION OF THE DRAWINGS

Some embodiments are illustrated by way of example and not limitation in the figures of the accompanying drawings.

FIG. 1 is a schematic block diagram illustrating a high-level network architecture of a system that retrieves data from a unified view, according to various embodiments described herein.

FIG. 2 is a schematic block diagram showing architectural aspects of a system for generating a unified view on a buffer table, according to various embodiments described herein.

FIG. 3 is a block diagram illustrating a representative software architecture, which may be used in conjunction with various hardware architectures herein described.

FIG. 4 is a block diagram illustrating components of a machine, according to some example embodiments, able to read instructions from a machine-readable medium (e.g., a machine-readable storage medium) and perform any one or more of the methodologies discussed herein.

FIG. 5 depicts aspects of an implementation of one or more components of a database server, according to various embodiments described herein.

FIG. 6 depicts aspects of a merge optimization system, according to various embodiments described herein.

FIG. 7 illustrates aspects of a process for generating and querying on a unified view, according to various embodiments described herein.

FIG. 8 illustrates aspects of a process for executing a buffer based data merge process, according to various embodiments described herein.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

The technology described herein provides a merge optimizer that improves the performance of a database platform when performing merge processes that merge external data into one or more tables stored in the database platform. The merge optimizer is used to implement optimized merge processes that enable database platforms to execute buffer-based, merge-on-read data merges. The optimized merge processes provided by the merge optimizer are a novel approach to merge processes that are more efficient than current state of the art copy-on-write merge processes that completely rewrites data tables each time any new rows are added or the data in any of the original rows is changed. Database platforms may use the merge optimizer to improve the efficiency of data merges by reducing the number of times a table is rewritten and, thereby, eliminating the computational and network resources used to perform the extra data writes. The merge optimization process also improves data accessibility, data accuracy, and data integrity, by providing a unified view of the changed data and the original data that is materialized so that the full dataset be accessed, queried, copied, transmitted, and otherwise used without having to wait for a copy-on-write merge process to be completed. The unified view may updated in real-time and at very low cost and the optimized merge processes may be scaled to very large datasets (i.e., tables with millions and/or billions of rows) to enable workflows that require frequent updates a small subset of records in a large data set to be executed in real time and at low cost. The optimized merge processes also enable time sensitive workflows that need to process changes to large datasets in real-time or near real-time.

To execute an optimized merge process, the merge optimizer writes changed data (e.g., new rows and/or updates to existing rows in a master table) received from an external table in a buffer table. The changed data may be continuously written to the buffer table in real-time and/or near-real time as it is added to an external table so that the changed data in the buffer table is up to data and the size of the buffer table increases as more of the changed data is stored in the table. The merge optimizer may create a unified view that joins the changed data in the buffer table with the original data in the master table. The unified view may be materialized so that the combination of the changed data and the original table may be accessed, queried, and used by one or more clients connected to the database platform. The merge optimizer may monitor one or more merge conditions (e.g., the size of the buffer table, the query performance on the unified view, and the like) to determine when the data in the buffer table is to be merged into the master table. When one or more merge conditions are met, a merge processor may write the changed data in the buffer table to the master table. The buffer table and the unified view may then be cleared and/or deleted after the changed data is merged into the master table. New changed data received from an external table may then be stored in a clean and/or new buffer table to restart the optimized merge process.

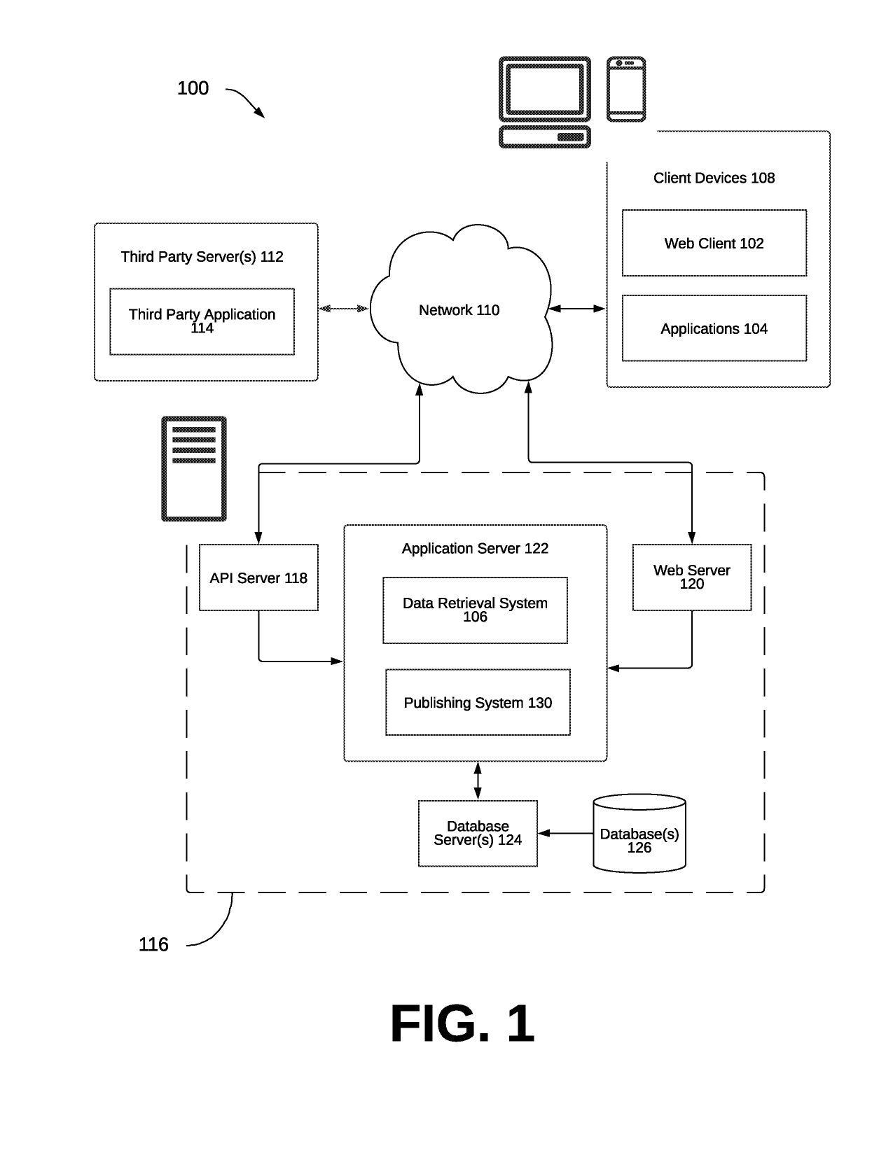

One or more clients may execute workflows on the database platform that use data stored in one or more tables updated using the merge optimizer. For example, a data retrieval system 106 included in the SaaS network architecture described in FIG. 1 below may process real-time updates to data in a master by querying on a unified view. The data retrieval system 106 may be a component of an application server 122 that may host one or more applications (e.g., a publishing system 130) that may use the data retrieved from the unified view. For example, the publishing system 130 may configure bids submitted to an online ad exchange based on real time event data provided by the data retrieval system 106. With reference to FIG. 1, an example embodiment of a high-level SaaS network architecture 100 is shown. A networked system 116 provides server-side functionality via a network 110 (e.g., the Internet or WAN) to a client device 108 (e.g., an internet enabled device). A web client 102 and a programmatic client, in the example form of a client application 104, are hosted and execute on the client device 108.

The networked system 116 includes an application server 122, which in turn hosts one or more applications 130 (e.g., server side applications configured to provide functionality and/or content to end-user clients) that provide a number of functions and services to the client application 104 that accesses the networked system 116. The client application 104 may provide a number of graphical user interfaces (GUIs) described herein that may be displayed on one or more client devices 108 and may receive inputs thereto to configure an instance of the client application 104 and monitor operations performed by the application server 122. The GUIs provided by the client application 104 may present outputs to a user of the client device 108 and receive inputs thereto in accordance with the methods described herein.

The client device 108 enables a user to access and interact with the networked system 116 and, ultimately, the data retrieval system 106, publishing system 130 or other applications hosted by the application server 122. For instance, the user provides input (e.g., touch screen input or alphanumeric input) to the client device 108, and the input is communicated to the networked system 116 via the network 110. In this instance, the networked system 116, in response to receiving the input from the user, communicates information back to the client device 108 via the network 110 to be presented to the user.

An API server 118 and a web server 120 are coupled, and provide programmatic and web interfaces respectively, to the application server 122. The application server 122 hosts the data retrieval, which includes components or applications described further below. The application server 122 may also host one or more applications that are linked to the learning module 106. For example, the application server 122 may host a publishing system 130 that distributes one or more pieces of content including image data or other media by submitting programmatic bids for ad placements to an online ad exchange. The application server 122 is, in turn, shown to be coupled to a database server 124 that facilitates access to information storage repositories (e.g., a database 126). In an example embodiment, the database 126 includes storage devices that store information accessed and generated by the data retrieval system 106, publishing system 130, and/or other applications.

Additionally, a third-party application 114, executing on one or more third-party servers 112, is shown as having programmatic access to the networked system 116 via the programmatic interface provided by the API server 118. For example, the third-party application 114, using information retrieved from the networked system 116, may support one or more features or functions of a generative AI system, website, streaming platform, and the like hosted by a third party.

Turning now specifically to the applications hosted by the client device 108, the web client 102 may access the various systems (e.g., the learning module 106) via the web interface supported by the web server 120. Similarly, the client application 104 (e.g., an agent evaluation “app”) accesses the various services and functions provided by the learning module 106 via the programmatic interface provided by the API server 118. The client application 104 may be, for example, an “app” executing on the client device 108, such as an iOS or Android OS application, and/or a desktop application, web application, or other software application to enable a user to access and input data on the networked system 116 in an offline manner and to perform batch-mode communications between the client application 104 and the networked system 116.

FIG. 1 illustrates one embodiment of the network architecture 100 and other embodiments may include one or more other components and/or configurations. For example, one or more of the data retrieval system 106 and/or publishing system 130 may be hosted by its own server. Further, while the SaaS network architecture 100 shown in FIG. 1 employs a client-server architecture, the present inventive subject matter is of course not limited to such an architecture, and could equally well find application in a distributed, or peer-to-peer, architecture system, for example. The data retrieval system could also be implemented as a standalone software program, which does not necessarily have networking capabilities.

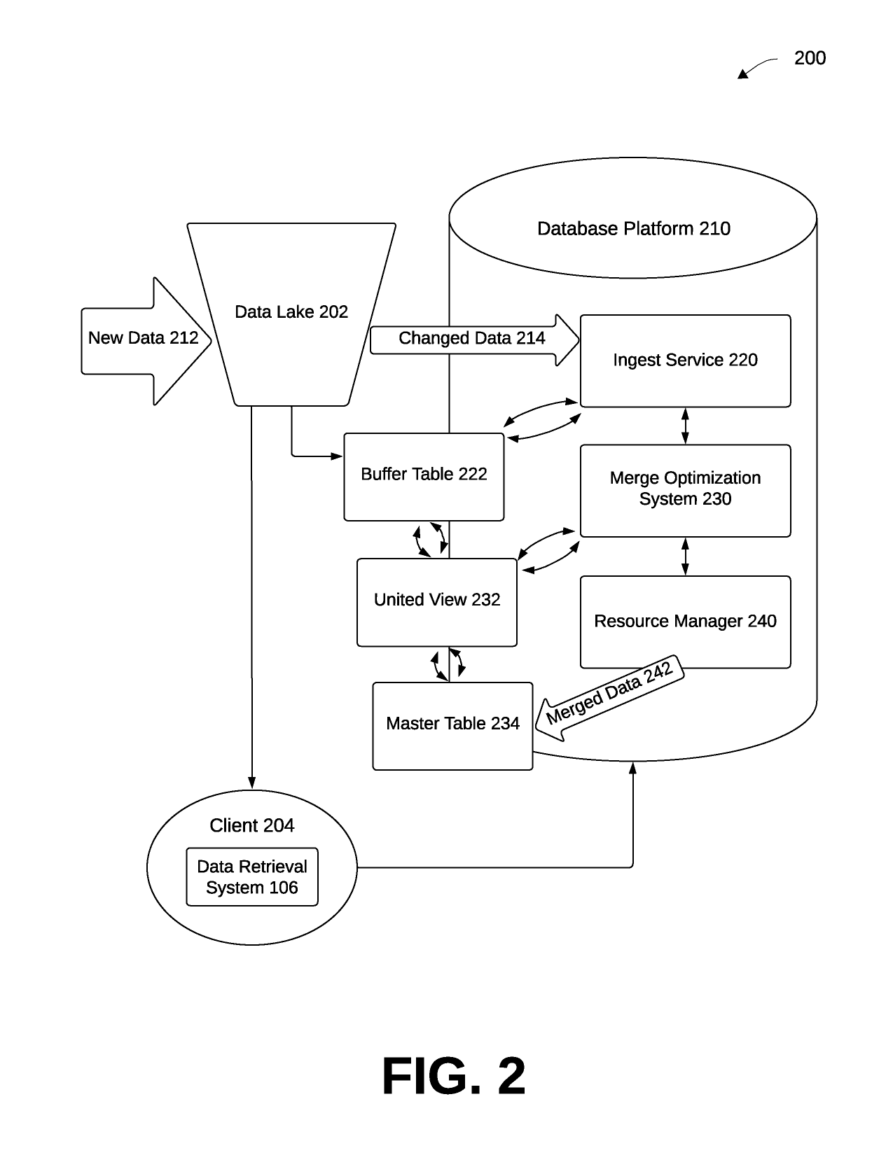

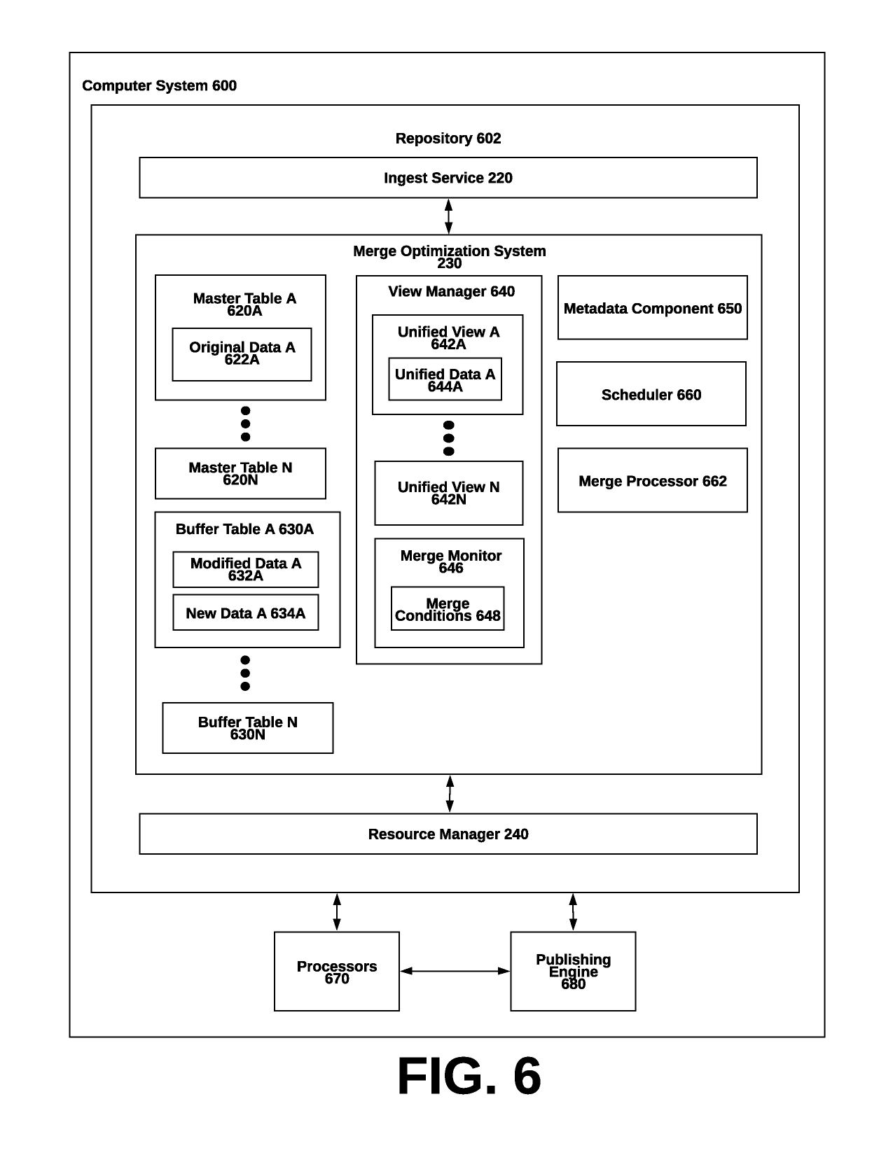

FIG. 2 illustrates a schematic block diagram of a system 200 for refreshing, merging, and querying data from an external table. The system 200 includes a database platform 210. The database platform 210 may be a cloud-based database computing platform for storing, organizing, maintaining, and querying database data. The database platform 210 may be in communication with multiple client accounts. An embodiment of the database platform 210 includes the merge optimization system 220 further illustrated in FIG. 6. The database platform 210 is in communication with a data lake 202 that receives data from a client 204. The data lake 202 may include a cloud-based data storage resource that may receive files and raw data in its native format.

A buffer table 222 may be generated based on data within the data lake 202. The buffer table 222 more store external data stored in the data lake 202. The external data may include structured or semi-structured data. The external is accessible to the database platform 210 but is not managed or updated by the database platform 210. In an embodiment, the external data is stored within the data lake 202 and the structure and organization of the external data is defined by the client 204. In an embodiment, the buffer table 222 is generated by the merge optimization system 220 and managed by the database platform 210. The structure and organization of the buffer table 222 may be defined by the database platform 210.

The data lake 202 includes a store of data that is managed by the client 204, wherein the client 204 is associated with the data lake 202 and the database platform 210. The data lake 202 may be external to the database platform 210 such that the database platform 210 does not have the ability or authorization to write or manipulate the data within the data lake 202. The database platform 210 may have permissions to read the data stored in the data lake 202, query the data stored in the data lake 202, and/or receive an indication when the data lake 202 is updated. An ingest service 220 may read the data stored in the data lake 202 to determine if the external data within the data lake 202 includes and changed data 214 that should be added to one or more master tables 232 within the database platform 210.

In an embodiment, the external data within the data lake 202 may be stored in an external table that is generated based on a source directory in the data lake 202. The source directory in the data lake 202 may alternatively be referred to as a namespace or source file. The source directory may be identified by the client 204 and the client 204 may manually indicate that new data should be uploaded to the source directory. The data lake 202 is a system or repository of data. Data within the data lake 202 may be stored in a structured or unstructured state at any scale. The data may be stored as-is without first structuring the data. In an embodiment, the data lake 202 is a single store of all enterprise data for the client 104, including raw copies of source system data and transformed data that may be utilized for tasks such as reporting, visualization, analytics, machine learning, and so forth. In an embodiment, the data lake 202 includes structured data from relational databases (i.e. rows and columns), semi-structured data, unstructured data (e.g. emails, documents, and so forth), and binary data (e.g. images, audio, video, and so forth). The data lake 202 may manage big data for the client 204 by providing a single point of collecting, organizing, and sharing data.

The data lake 202 may be distinguished from a data warehouse. However, in certain embodiments, a data warehouse may be utilized rather than a data lake 202 is illustrated in FIG. 1. A data warehouse includes a database optimized to analyze relational data coming from transaction systems and line of business applications. In a data warehouse, the data structure and schema may be defined in advance to optimize for fast queries. The data in a data warehouse may be cleaned, enriched, and transformed such that it acts as a single source of truth. The data lake 202 may store relational data from line of business applications and non-relational data from, for example, mobile applications, internet of things devices, and social media. In a data lake 202, the structure or schema of the data may not be defined when data is captured such that all data may be stored without careful design. In certain implementations, it may be beneficial to employ both a data warehouse and a data lake, and such an implementation may benefit from the systems, methods, and devices for generating a materialized view based on an external table, as disclosed herein.

The data lake 202 may import any amount of new data 212 that may be ingested in real time. The new data 212 may be collected from multiple sources and moved to the data lake 202 in its original format. This process may permit the data lake 202 to scale data of any size while saving time defining data structures, schema, and transformations. The data lake 202 may provide an ability to understand what data is stored in the data lake 202 through crawling, cataloging, and indexing the data. The data within the data lake 202 may be secured and encrypted to ensure the data is protected.

The data lake 202 provides directories for the tables storing external data and a materialized view. The directories may be stored in a different file format than the tables stored in the shared storage devices of the database platform 210. The directories of the data lake 202 may be stored in a cloud storage system such as Amazon Web Services™, Microsoft Azure™, and so forth. The data lake 202 may be separate and independent of the database platform 210.

The client 204 may add new data 212 to the data lake 202. The new data 212 may be in any file format. In an embodiment, the new data 212 must be in a specific file format to be read by the database platform 212 or to be incorporated into the data lake 202. In an embodiment, the database platform 210 includes shared storage devices for storing database data (this may be referred to as “internal” data that is managed by the database platform 210). The client 204 may have data stored in the data lake 202 and may further have different or replicated data that is stored in the shared storage devices of the database platform 210. In an embodiment, the data stored in the data lake 202 and the data stored in the shared storage devices of the database platform 210 have different file formats. In such an embodiment, the ingest service 220 of the database platform 210 may be configured to read the different formats for data stored in the data lake 202 and/or convert those different formats to the same data format used by the database platform 210.

When the new data 212 is added to the data lake 202, a notification is generated and provided to an ingest service 220 of the database platform 210. The notification includes an indication that the new data 212 has been added to the data lake 202. The notification may be automatically generated by the data lake 202, may be automatically or manually generated by the client 204, may be automatically or manually retrieved by the database platform 210, and so forth. In an embodiment, the database platform 210 queries the data lake 202 at threshold periods to determine whether new data 212 has been added to the data lake 202. In an embodiment, the notification is provided to the ingest service 220 to indicate that new data 212 has been received by the data lake 202. The ingest service 220 may query, crawl, catalog, index, search or analyze, the new data 212 to determine if the new data 212 includes any changed data 214 (e.g., updates, refreshes, and/or modifications to the data in the database platform 210). When changed data 214 is identified, the ingest service 220 may prompt an update to be made to the buffer table 222 and further to a unified view 232 based on the new data 212.

The ingest service 220 receives notifications from the data lake 202 that an update has been made do data stored within the data lake 202. The ingest service 220 may receive a notification that data within the source directory (may alternatively be referred to as a namespace or source file) in the data lake 202 has been updated. The ingest service 220 updates metadata for the tables within the data lake 202 to reflect any modifications made to the data lake 202 data.

The new data 212 is read and/or retrieved by the ingest service 220 of the database platform 210. The new data 212 is stored in an external table. The external table may be in communication with the database platform 210 but may not be managed by the database platform 210. In an embodiment, the database platform 210 can read data in the external table but cannot write data to the external table. In an embodiment, the client 204 manages the external table and provides access to the external table to the database platform 210. In an embodiment, the external table is managed and/or provided by a cloud-based data warehousing service that may be separate and independent of the database platform 210. When new data 212 is added to the data lake 202, the external table is updated to reflect the new data 212.

When changed data 214 within the new data 212 is identified by the ingest service 220, the changed data 214 may be written to a buffer table 222. In an embodiment, the buffer table 222 may be in communication with the database platform 210 but may not be managed by the database platform 210. In an embodiment, the database platform 210 can read data in the buffer table 222 but cannot write data to the buffer table 222. In an embodiment, the client 204 manages the buffer table 222 and provides access to the buffer table 222 to the database platform 210. In an embodiment, the buffer table 222 is managed and/or provided by a cloud-based data warehousing service that may be separate and independent of the database platform 210. When new data 212 is added to the data lake 202 and changed data 214 is identified in the new data 212, the buffer table is updated to reflect the new changed data 214.

In an embodiment, the buffer table 222 may be generated by and managed by the database platform 210. For example, the buffer table 222 may be generated by the ingest service 220 or merge optimization system 230. In an embodiment, the database platform 210 can read data in the buffer table 222 and write data to the buffer table 222. In an embodiment, the buffer table 222 is managed and/or provided by the database platform 210 and may be internal to the database platform 210. When new data 212 is added to the data lake 202, the buffer table 222 is updated by the database platform 210 to reflect the new data 212 and/or changed data 214 identified in the new data 212.

The database platform 210 may generate one or more unified views 232 based on the buffer table 222. The unified view 232 may be materialized so that the unified view 232 is a materialized view over the buffer table 222 and one or more master tables 234 of the database platform. The unified view 232 queried so that the combined data in the buffer table 222 and the master table 234 may be accessed and used. The unified view 232 may be managed by the database platform 210 and may be stored in the plurality of shared storage devices that are associated with the database platform 210. When new data 212 is added to the data lake 202, the buffer table 222 is updated and the unified view 232 over the buffer table 222 is refreshed.

The database platform 210 generates the unified view 232 over the buffer table 222. The generation of the unified view 232 over the buffer table 222 may be decomposed into two steps. In a first step, a non-materialized table is generated by joining the data in the buffer table 222 with the data in the one or more master tables 234 that have changed data 214 stored in the buffer table 222. In a second step, a unified view 232 is generated over the non-materialized table. In certain implementations, it may be beneficial to decompose the non-materialized table from the unified view 232 as disclosed herein. Decomposing may allow for multiple different unified views 232 to be generated, and each of the multiple unified views 232 may include a different selection of data, different projections, different summaries, and so forth, without first materializing all of the source data.

The combination of a non-materialized table and a unified view 232 over the buffer table 222 and master table 234 may be beneficial in implementations where a large amount of data is already stored in the data lake 202 and only the subset of that data that is needed to updated the master tables 234 (e.g., the changed data 214) is frequently queried. In such an implementation, it may be cost-prohibitive to materialize all of the data in the data lake 202. Further, generating a materialized view over the buffer table 222 may permit materialization of only the portion of the data in the data lake 202 that is queried most frequently.

The merge optimization system 230 may include a metadata component (e.g., 650 depicted in FIG. 6) that generates and refreshes metadata based on the data in the data lake 202 and/or buffer table 222. The metadata is generated, managed, stored, and refreshed by the database platform 210. The metadata is information about the data stored in the data lake 202 and/or the buffer table 222. The metadata may be organized according to the improved metadata systems disclosed herein, for example those depicted in FIG. 6. The metadata includes information about the data stored in the data lake 202 and/or the buffer table 222 such that a resource manager 240 of the database platform 210 can execute queries over the buffer table 222 without reading all data in the external table. The metadata may also include information about the data stored in the master table 234 such that the resource manager 240 can merge changed data 214 from the buffer table 222 with original data in the master table 234 without reading and/or writing all data in the master table 234.

The metadata component further generates and refreshes metadata about the unified view 232. When the data lake 202 and/or the buffer table 222 are updated, the unified view 232 may be refreshed to reflect the updates. The metadata may further be refreshed by the metadata component to reflect the updates made to the unified view 232. When the 204 queries the unified view, the resource manager of the database platform 210 may execute the query on the unified view 232 if a unified view 232 exists that can respond to the query. The database platform 210 expends less time and processing resources when the query is executed over the unified view 210 rather than the first running the query on the relevant master table then running the query on the full external table including the changed data then joining the results of the two queries to obtain the results over the original data in the master table and the updates to the master table included in the external table.

The client 204 may query the buffer table 222 metadata by way of various methods. In an embodiment, a view shows all the buffer tables 222 in the database. The columns in such a result are similar to those of regular tables, while the buffer table 222 will have additional columns. In an embodiment, the buffer table 222 includes a notification channel column that specifies a resource name of a simple queue service (SQS) queue that is created in the back end such that a client account may setup automatic addition of files to the buffer table 222. In an embodiment, the buffer table 222 includes a location column that specifies the location which the buffer table 222 is configured with.

A metadata view indicates the directories that supply data to the buffer table. Where the source of the data is the data lake 202, new files may be added at any time, old files may be deleted at any time, and files may be updated at any time. In such an embodiment, it may be beneficial to generate a metadata view of all files that supply data to the buffer table 222. In an embodiment, all directories for the buffer table 222 are tracked and such data is available to view in an information schema. directories that are de-registered or deleted may be removed from the metadata view.

The unified view 234 may be generated over a buffer table 222 and master table 234 to provide for faster query response time and provide real-time or near real-time access to updates to a large dataset stored in the database platform 210. The unified view 234 may be automatically and incrementally updated to ensure that data is always up-to-date with a primary source of truth, such as a source directory in the data lake 202. The fast query may be processed against the unified view 232 to improve query response time on frequently used data. The metadata generated by the merge optimization system 230 may be used to monitor one or more merge conditions. A client account may define and/or tune the merge conditions based on the client’s needs, resource costs, and the performance of the database platform. When the merge optimization system 230 detects one or more merge conditions is satisfied, a resource manager may execute a merge process that updates a master table 234 by writing merged data 242 (e.g., the changed data 214 in the buffer table 222) to the master table 234. In an embodiment, the resource manager 240 may execute the merge process by writing all of the changed data 214 in the buffer table 222 and re-writing all of the original data in the master table 234 in a new updated master table 234. In an embodiment, the resource manager 240 may execute the merge process by writing the new rows of data in the changed data 214 to the original master table 234 and only re-writing the rows of the master table 234 that are updated by the changed data 214. This process may be more efficient and faster than current state of the art merge processes that rewrite all of the rows in the original table even if the rows are not updated.

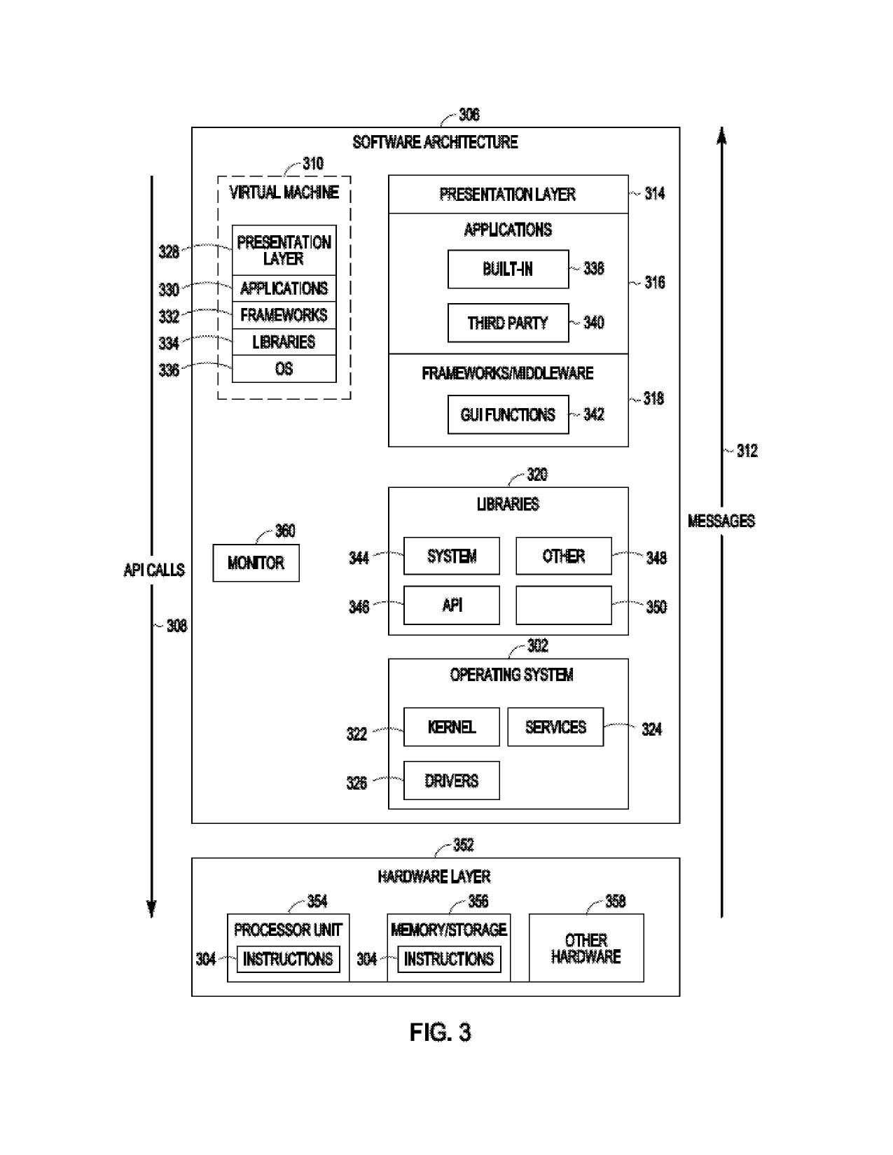

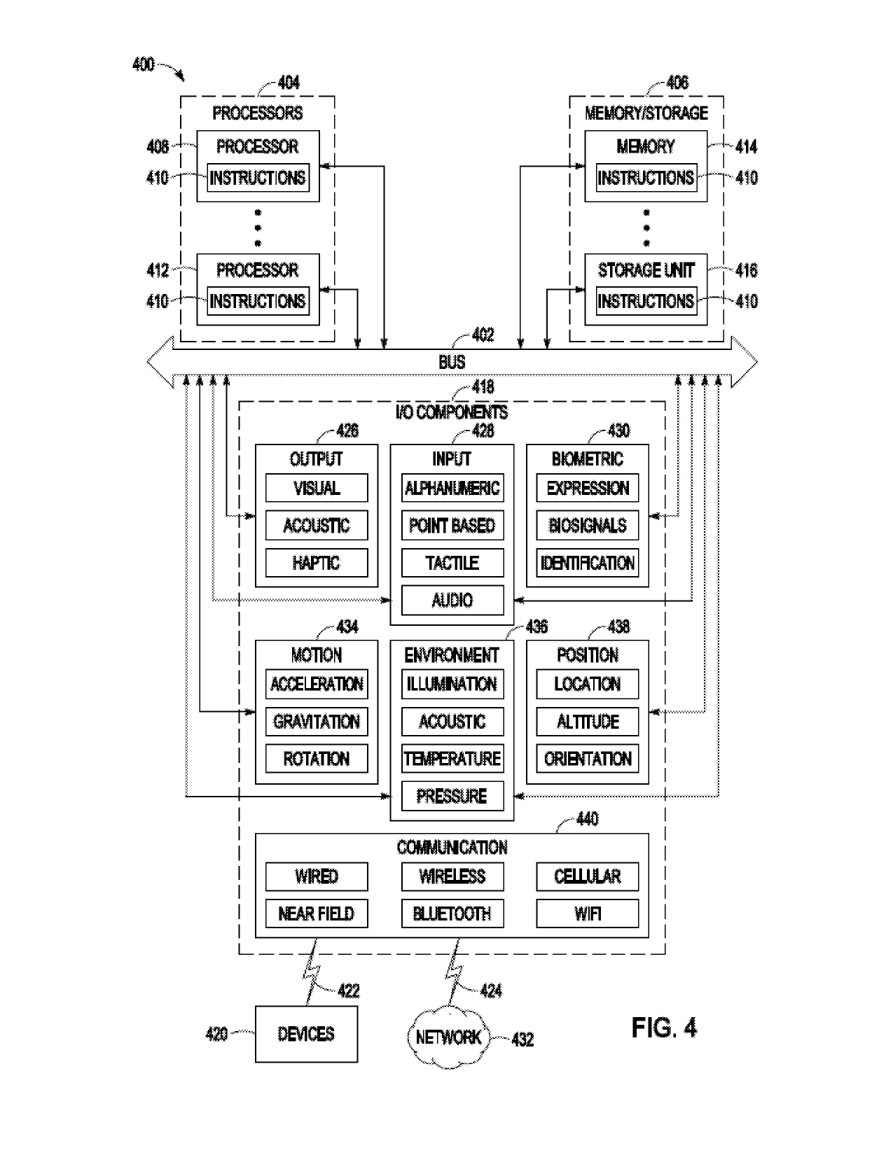

FIG. 3 is a block diagram illustrating an example software architecture 306, which may be used in conjunction with various hardware architectures herein described. FIG. 3 is a non-limiting example of a software architecture 306, and it will be appreciated that many other architectures may be implemented to facilitate the functionality described herein. The software architecture 306 may execute on hardware such as a machine 400 of FIG. 4 that includes, among other things, processors 404, memory/storage 406, and input/output (I/O) components 418. A representative hardware layer 352 is illustrated and can represent, for example, the machine 400 of FIG. 4. The representative hardware layer 352 includes a processor 354 having associated executable instructions 304. The executable instructions 304 represent the executable instructions of the software architecture 306, including implementation of the methods, components, and so forth described herein. The hardware layer 352 also includes memory and/or storage modules as memory/storage 356, which also have the executable instructions 304. The hardware layer 352 may also comprise other hardware 358.

In the example architecture of FIG. 3, the software architecture 306 may be conceptualized as a stack of layers where each layer provides particular functionality. For example, the software architecture 306 may include layers such as an operating system 302, libraries 320, frameworks/middleware 318, applications 316, and a presentation layer 314. Operationally, the applications 316 and/or other components within the layers may invoke API calls 308 through the software stack and receive a response as messages 312 in response to the API calls 308. The layers illustrated are representative in nature, and not all software architectures have all layers. For example, some mobile or special-purpose operating systems may not provide a frameworks/middleware 318, while others may provide such a layer. Other software architectures may include additional or different layers.

The operating system 302 may manage hardware resources and provide common services. The operating system 302 may include, for example, a kernel 322, services 324, and drivers 326. The kernel 322 may act as an abstraction layer between the hardware and the other software layers. For example, the kernel 322 may be responsible for memory management, processor management (e.g., scheduling), component management, networking, security settings, and so on. The services 324 may provide other common services for the other software layers. The drivers 326 are responsible for controlling or interfacing with the underlying hardware. For instance, the drivers 326 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 320 provide a common infrastructure that is used by the applications 316 and/or other components and/or layers. The libraries 320 provide functionality that allows other software components to perform tasks in an easier fashion than by interfacing directly with the underlying operating system 302 functionality (e.g., kernel 322, services 324, and/or drivers 326). The libraries 320 may include system libraries 344 (e.g., C standard library) that may provide functions such as memory allocation functions, string manipulation functions, mathematical functions, and the like. In addition, the libraries 320 may include API libraries 346 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 320 may also include a wide variety of other libraries 348 to provide many other APIs to the applications 316 and other software components/modules.

The frameworks/middleware 318 provide a higher-level common infrastructure that may be used by the applications 316 and/or other software components/modules. For example, the frameworks/middleware 318 may provide various graphic user interface (GUI) functions 342, high-level resource management, high-level location services, and so forth. The frameworks/middleware 318 may provide a broad spectrum of other APIs that may be utilized by the applications 316 and/or other software components/modules, some of which may be specific to a particular operating system or platform.

The applications 316 include built-in applications 338 and/or third-party applications 340. Examples of representative built-in applications 338 may include, but are not limited to, a contacts application, a browser application, a book reader application, a location application, a media application, a messaging application, a publishing application, a content application, a campaign configuration application, performance monitoring application, a scoring application, and/or a game application. The third-party applications 340 may include any application developed using the ANDROID™ or IOS™ software development kit (SDK) by an entity other than the vendor of the particular platform and may be mobile software running on a mobile operating system such as IOS™, ANDROID™, WINDOWS® Phone, or other mobile operating systems. The third-party applications 340 may invoke the API calls 308 provided by the mobile operating system (such as the operating system 302) to facilitate functionality described herein.

The applications 316 may use built-in operating system functions (e.g., kernel 322, services 324, and/or drivers 326), libraries 320, and frameworks/middleware 318 to create user interfaces to interact with users of the system. Alternatively, or additionally, in some systems, interactions with a user may occur through a presentation layer, such as the presentation layer 314. In these systems, the application/component “logic” can be separated from the aspects of the application/component that interact with a user.

Some software architectures use virtual machines. In the example of FIG. 3, this is illustrated by a virtual machine 310. The virtual machine 310 creates a software environment where applications/components can execute as if they were executing on a hardware machine (such as the machine 400 of FIG. 4, for example). The virtual machine 310 is hosted by a host operating system (e.g., the operating system 302 in FIG. 3) and typically, although not always, has a virtual machine monitor 360, which manages the operation of the virtual machine 310 as well as the interface with the host operating system (e.g., the operating system 302). A software architecture executes within the virtual machine 310 such as an operating system (OS) 336, libraries 334, frameworks 332, applications 330, and/or a presentation layer 328. These layers of software architecture executing within the virtual machine 310 can be the same as corresponding layers previously described or may be different.

FIG. 4 is a block diagram illustrating components of a machine 400, according to some example embodiments, able to read instructions from a non-transitory machine-readable medium (e.g., a non-transitory machine-readable storage medium) and perform any one or more of the methodologies discussed herein. Specifically, FIG. 4 shows a diagrammatic representation of the machine 400 in the example form of a computer system, within which instructions 410 (e.g., software, a program, an application, an applet, an app, or other executable code) for causing the machine 400 to perform any one or more of the methodologies discussed herein may be executed. As such, the instructions 410 may be used to implement modules or components described herein. The instructions 410 transform the general, non-programmed machine 400 into a particular machine 400 programmed to carry out the described and illustrated functions in the manner described. In alternative embodiments, the machine 400 operates as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 410, sequentially or otherwise, that specify actions to be taken by the machine 400. Further, while only a single machine 400 is illustrated, the term “machine” shall also be taken to include a collection of machines that individually or jointly execute the instructions 410 to perform any one or more of the methodologies discussed herein.

The machine 400 may include processors 404 (including processors 408 and 412), memory/storage 406, and I/O components 418, which may be configured to communicate with each other such as via a bus 402. The memory/storage 406 may include a memory 414, such as a main memory, or other memory storage, and a storage unit 416, both accessible to the processors 404 such as via the bus 402. The storage unit 416 and memory 414 store the instructions 410 embodying any one or more of the methodologies or functions described herein. The instructions 410 may also reside, completely or partially, within the memory 414, within the storage unit 416, within at least one of the processors 404 (e.g., within the processor’s cache memory), or any suitable combination thereof, during execution thereof by the machine 400. Accordingly, the memory 414, the storage unit 416, and the memory of the processors 404 are examples of machine-readable media.

The I/O components 418 may include a wide variety of components to receive input, provide output, produce output, transmit information, exchange information, capture measurements, and so on. The specific I/O components 418 that are included in a particular machine will depend on the type of machine. For example, portable machines such as mobile phones will likely include a touch input device or other such input mechanisms, while a headless server machine will likely not include such a touch input device. It will be appreciated that the I/O components 418 may include many other components that are not shown in FIG. 4. The I/O components 418 are grouped according to functionality merely for simplifying the following discussion, and the grouping is in no way limiting. In various example embodiments, the I/O components 418 may include output components 426 and input components 428. The output components 426 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 428 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 418 may include biometric components 430, motion components 434, environment components 436, or position components 438, among a wide array of other components. For example, the biometric components 430 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 434 may include acceleration sensor components (e.g., accelerometer), gravitation sensor components, rotation sensor components (e.g., gyroscope), and so forth. The environment components 436 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas sensors to detect concentrations of hazardous gases for safety or to measure pollutants in the atmosphere), or other components that may provide indications, measurements, or signals corresponding to a surrounding physical environment. The position components 438 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 418 may include communication components 440 operable to couple the machine 400 to a network 432 or devices 420 via a coupling 424 and a coupling 422, respectively. For example, the communication components 440 may include a network interface component or other suitable device to interface with the network 432. In further examples, the communication components 440 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 420 may be another machine or any of a wide variety of peripheral devices (e.g., a peripheral device coupled via a USB).

Moreover, the communication components 440 may detect identifiers or include components operable to detect identifiers. For example, the communication components 440 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 440, such as location via Internet Protocol (IP) geo-location, location via Wi-Fi® signal triangulation, location via detecting an NFC beacon signal that may indicate a particular location, and so forth.

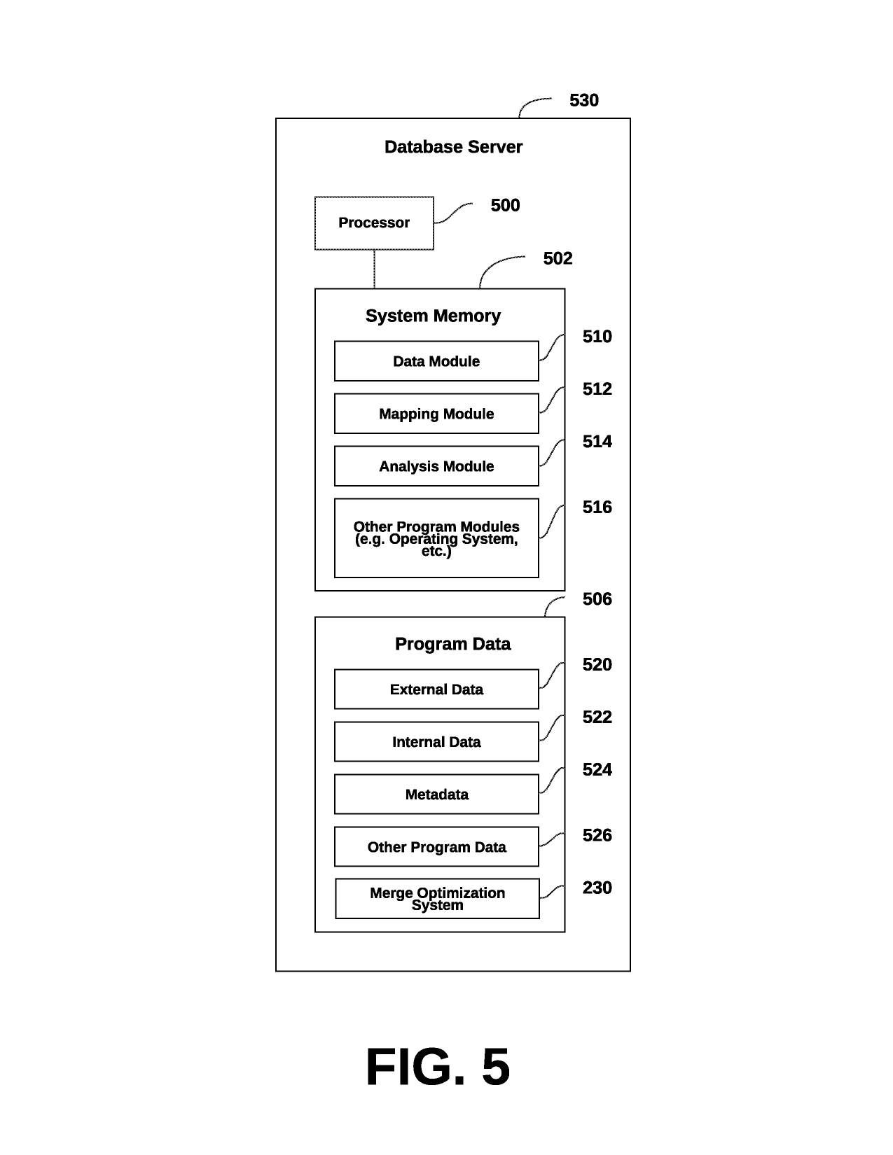

FIG. 5 illustrates a database server 530 hosting a merge optimization system. The database server 530 may include at least one processor 500 coupled to a system memory 502 that may include computer program modules 504 and program data 506. In various embodiments, program modules 504 may include a data module 510, a model module 512, a training module 514, and other program modules 516 such as an operating system, device drivers, and so forth. Each module 510 through 516 may include a respective set of computer-program instructions executable by one or more processors 500.

This is one example of a set of program modules, and other numbers and arrangements of program modules are contemplated as a function of the particular design and/or architecture of the learning module. Additionally, although shown as a single database server, the operations associated with respective computer-program instructions in the program modules 504 could be distributed across multiple computing devices. Program data 506 may include data, program instructions, and other resources consumed by the program modules 504 to provide the functionality described herein. In various embodiments, program data 506 may include external data 520 (e.g., external data retrieved from a data lake), internal data 522 (e.g., internal data stored in a database platform), metadata 524, and other program data 526 such as data input(s), third-party data, and/or others. Program data 506 may also include instructions, data, and other resources used to implement the merge optimization system 230 described further below.

FIG. 6 is a block diagram illustrating more details of a merge optimization system 230 in accordance with one or more embodiments of the disclosure. The merge optimization system may be implemented using a computer system 600 that may include a repository 602, publishing engine 680, and one or more computer processors 670. The computer system 600 may take the form of the database platform described above in FIG. 2 or any other computer including a processor and memory. The computer processor(s) 670 may take the form of the processor 500 described in FIG. 5.

The repository 602 may include an ingest service 220 connected to a merge optimization system 230. The ingest service 220 may query one or more external tables (e.g., tables in a data lake) to identify changed data for one or more master tables 620A,…,620N in a database platform. The ingest service 220 may retrieve the changed data from one or more external tables. The merge optimization system 230 may write the changed data identified by the ingest service 220 to one or more buffer tables 630A,…,630N. The changed data stored in a buffer table 630A may include new data 634A (e.g., new rows of data) that may be appended to the rows including original data 622A in a master table 620A. The changed data may also include modified data 632A that includes one or more changes to one or more rows of original data 622A.

A view manager 640 of the merge optimization system 230 may generate one or more unified views 642A,…,642N based on the buffer tables 630A,…,630N and the master tables 620A,…,620N. The view manager 640 may generate a unified view 642A by joining the rows of data in the buffer table 630A with the rows of data in the master table 620A. The unified view 642A may be materialized by the view manager 640 to enable queries to be executed on the combined set of new data 634A and modified data 632A stored in the buffer table 630A and the original data 622A in the master table 620A. The unified view 642A may be used to efficiently query an updated version of the data stored in the master table 620A before the changed data is merged into the master table 620A (e.g.. before the new data 634A and the modified data 632A are written to the master table 620A).

A metadata component 650 may generate metadata based on the master tables 620A,…,620N, buffer tables 630A,…,630N, and/or the unified views 642A,…,642N. The metadata may include, for example, a size measurement (e.g., the number of rows, number of bytes, size relative to another table (e.g., 10% of the rows included in the master table), number of unique identifiers, and the like) of a master table 620A and/or buffer table 630A. The metadata may also include a size of the unified view and/or a performance metric for a unified view 642A. For example, the performance metric may include an amount of time required to execute a query on the unified view 642A. A merge monitor 646 may read the metadata generated by the metadata component 650 and compare one or more pieces of metadata (e.g., a size measurement of the buffer table 630A, a size measurement of the unified view 642A, a performance metric for the unified view 642A, and the like) to a merge condition 648. If the metadata satisfies a merge condition 648, the merge monitor 646 may initiate a data merge process that adds the changed data in the buffer table 630A to the master table 620A.

To execute the merge operation, the merge monitor 646 may send a notification to a scheduler 660 to schedule a merge operation. The scheduler 660 provides an additional layer of control over when merge operations occur. By scheduling merges during off-peak hours or at specific intervals, the scheduler 660 can further optimize resource usage and reduce costs. The merge processor 662 may execute the merge process at the time set by the scheduler 660. To execute the merge process, the merge processor 662 may use processing and memory resources provided by the resource manager 640. The merge processor 662 efficiently combines data from the buffer table 630A with the master table 620A. To combine the data, the merge processor 670 identifies the rows in the master table 620A that need to be updated or inserted and uses resources provided by the resource manager 240 to perform the necessary read and write operations. The merge processor 662 may configure the merge process to minimize write amplification and resource consumption, making the merge process both cost-effective and fast.

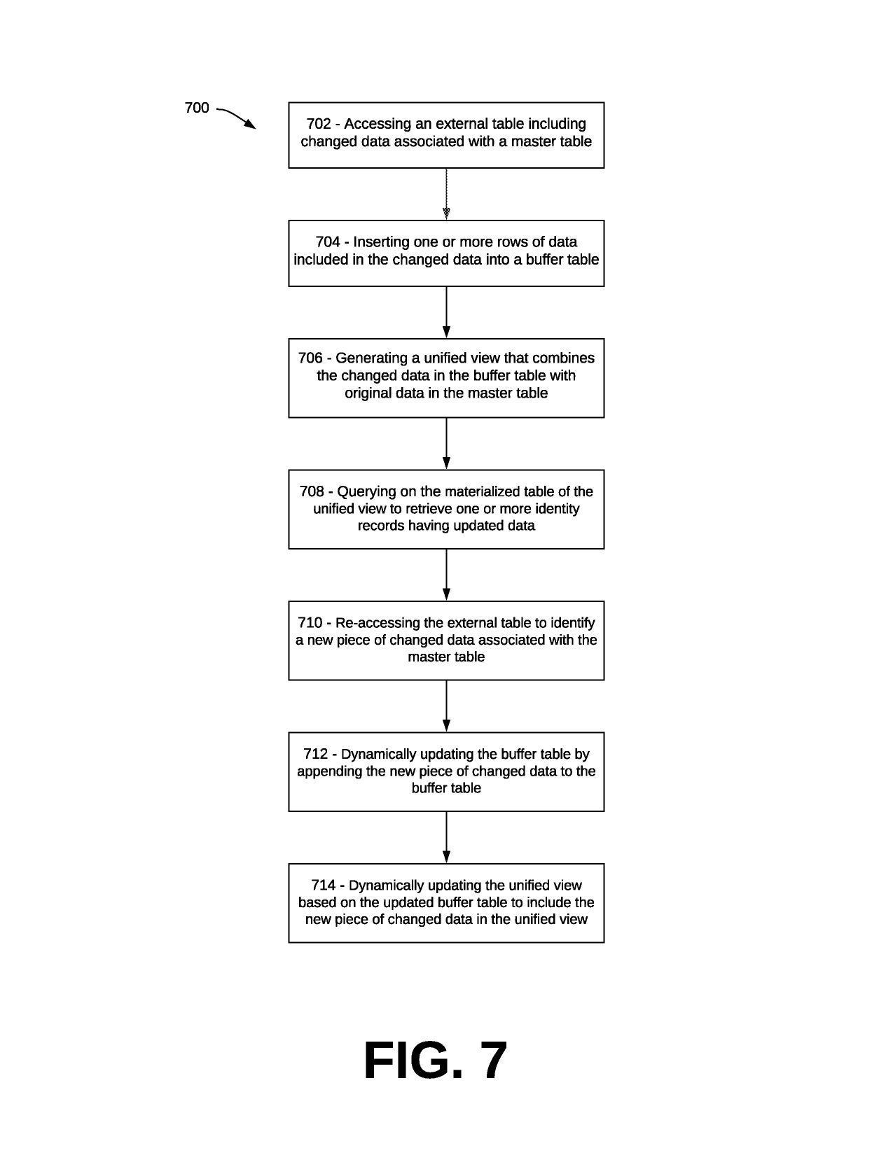

Embodiments of the present invention may also include methods. FIG. 7 is a block diagram that illustrates an example method of generating a unified view. At step 702, a component of a database platform (e.g., a merge optimization system) accesses an external table including changed data associated with a master table. In various embodiments, the external table may be stored in a data lake, data warehouse, or other storage device that is external to a database platform. The master table may be stored in the database platform and the external table may include changed data used to update the master table. For example, the changed data may include one or more rows of data that are used to update one or more records in the master table. The changed data may also include one or more rows of data that include new records that should be added to the master table.

At step 704, the database platform may insert one or more rows of data included in the changed data into a buffer table. In various embodiments, the buffer table may be generated by a merge optimization system and may be stored in the database platform with the database platform having read and write access to the buffer table. At step 706, the merge optimization system may generate a unified view that combines the changed data in the buffer table and original data in the master table. In various embodiments, the unified view may include a materialized table to enable one or more clients having access to the database platform to query one the unified view. In various embodiments the unified view may be generated by cachinga join result of one or more rows of the master table and one or more rows of the buffer table in memory of the database platform. The unified view may also generate one or more non-materialized table storing a result of a join operation on one or more rows of the master table and one or more rows of the buffer table. One or more materialized versions of the non-materialized tables may then be generated to create the unified view so that the unified view is configured to enable one or more devices to run one or more queries on the materialized version of the table.

At step 708, the database platform may query on the materialized table of the unified view to retrieve one or more identity records having one or more pieces of the changed data. In various embodiments, the database platform may execute one or more queries received from one or more clients. The database platform may execute the queries on the unified view in order to provide updates to the data in the master table to one or more clients. The updated data provided by querying on the unified view may be used by the one or more clients in workflows that require access to real-time or near real time data. For example, an audience segmentation workflow that uses real-time events data collected for one or more identifiers (e.g., cookies, device ids, or other identifiers) to determine audiences for a media campaign (e.g., display media campaign, email campaign, and the like).

At step 710, the database platform may re-access the external table to identify a new piece of changed data associated with the master table. The database platform may receive a notification from a data lake or other storage device storing the external table. The database platform may then query on the external table in response to receiving the notification to identify and/or retrieve the new piece of changed data in real-time. At step 712, the merge optimization system may dynamically update the buffer table by appending the new piece of changed data to the buffer table. At step 714, the merge optimization system may make an updated version of the master table that includes the new piece of changed data available for one or more client devices to query on by updating the unified view based on the updated buffer table to include the new piece of changed data in the unified view.

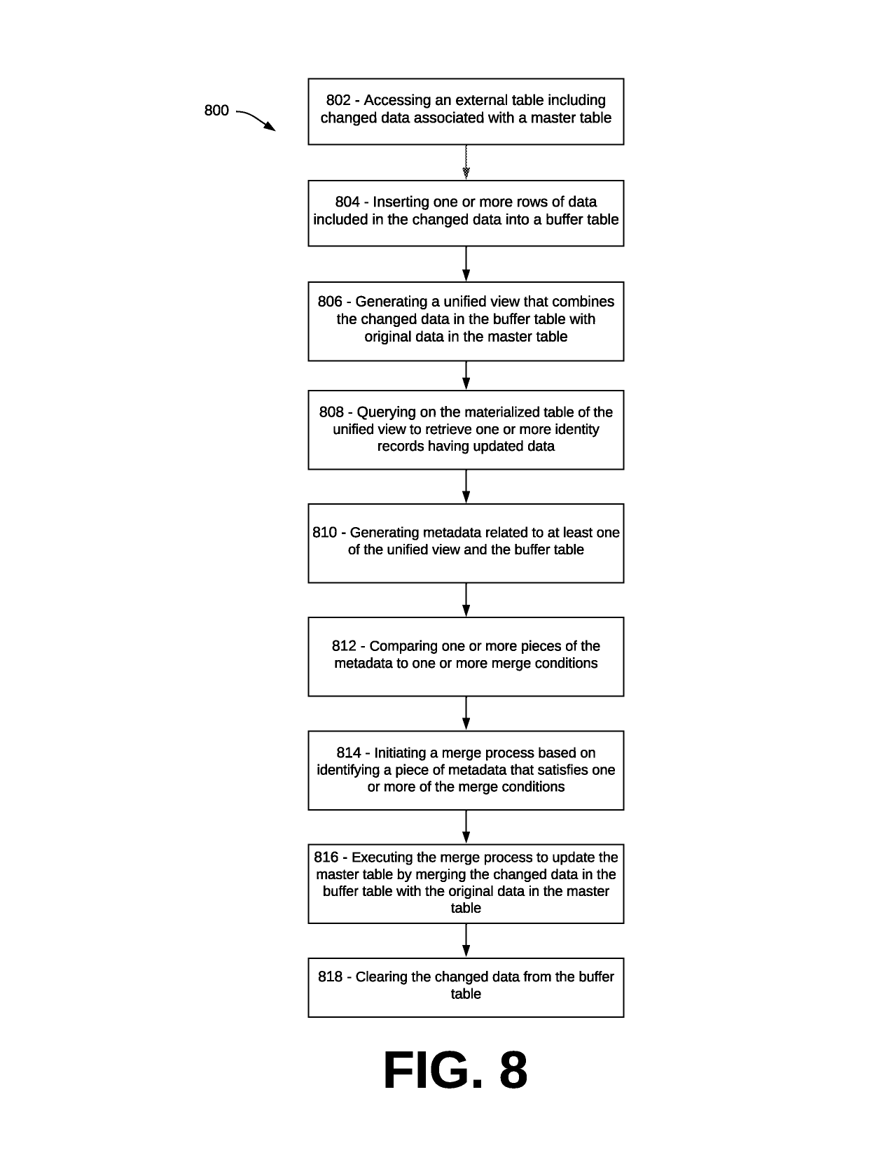

FIG. 8 illustrates a flow diagram of an example buffer-based merge process 800 for intelligently updating a large data table (also referred to herein as a “master table”) while minimizing costly table rewrites. In various embodiments, process 800 may be performed by a database platform (e.g., database platform 210), optionally in cooperation with a merge optimization system (e.g., merge optimization system 230), a view manager, a metadata component, a merge monitor, a scheduler, a merge processor, and/or a resource manager (e.g., as described with respect to FIGS. 2 and 6). In the example of FIG. 8, updated data is made queryable in real-time or near-real time through a unified view that overlays changed data onto the master table, and a merge of the changed data into the master table is initiated selectively based on merge conditions that are derived from metadata, including performance degradation of the unified view and/or its materialized table.

For purposes of FIG. 8, the following terms are used throughout the description. A “master table” is a primary or canonical table managed by the database platform that stores original data (e.g., millions or billions of rows) and is treated as a primary target for durable updates. An “external table” is a table external to the database platform’s managed storage (e.g., a table backed by files in a data lake or other external storage), and may function as a source of truth for incoming changes to be applied to the master table. “Changed data” refers to one or more rows (and/or row fragments) representing updates to existing master-table rows and/or new rows to be appended to the master table. A “buffer table” is an internal table managed by the database platform that stores changed data (e.g., as an append-only or incremental log of changes) prior to (or in lieu of) rewriting the master table. A “unified view” is a logical representation that combines original data in the master table with changed data in the buffer table such that the combined dataset is queryable before an expensive physical merge is executed. In some embodiments, the unified view includes (or is backed by) one or more non-materialized tables and one or more materialized tables, where a “materialized table” caches a join result (or other combination result) of at least a portion of the master table and at least a portion of the buffer table so that queries may be executed without repeatedly recomputing the join/overlay operation. An “identity record” refers to a record keyed by an identifier (e.g., a primary key, a device identifier, a cookie identifier, an account identifier, etc.), and “identity records having updated data” refers to identifiers and/or rows for which the buffer table contains changes relative to the master table. “Metadata” refers to statistics, measurements, and/or operational signals generated for the buffer table and/or unified view (including its materialized table) that describe at least table size and/or query performance. “Merge conditions” refer to one or more rules, thresholds, predicates, or policies that are evaluated against metadata to determine whether (and/or how) a merge operation should occur.

At step 802, a database platform may access an external table including changed data associated with a master table. In some embodiments, accessing the external table includes polling, scanning, subscribing to notifications, or otherwise detecting newly arrived external data files or rows that correspond to updates for one or more master tables. The external table may include incremental “delta” records, event logs, batched updates, streaming updates, or combinations thereof. For example, if a master table stores a large identity-profile dataset (e.g., profile attributes for millions of identifiers), the external table may include a rolling feed of attribute updates (e.g., “identifier=123, attribute=city, value=San Jose”) and/or new identifiers to be inserted.

At step 804, the merge optimization system (or other component of the database platform) may insert one or more rows of data included in the changed data into a buffer table. In various embodiments, inserting into the buffer table may include appending new rows, writing change records with timestamps and/or sequence numbers, and/or recording an operation type for each change (e.g., INSERT, UPDATE, DELETE, UPSERT). In some embodiments, the buffer table stores only the changed subset of the overall dataset (e.g., only the identifiers that have new or modified values), thereby decoupling the pace of change ingestion from the expensive cost of rewriting the large master table. In certain implementations, the buffer table is organized to support efficient “overlay” semantics, such as by indexing on the master-table primary key, partitioning by identifier ranges, or clustering by recency, so that later steps can resolve “which version of a row wins” without scanning the full master table.

At step 806, the merge optimization system may generate a unified view that combines the changed data in the buffer table with original data in the master table. In some embodiments, the unified view implements “merge-on-read” semantics, where query results reflect the master table as if it had already been updated, even though the master table has not yet been physically rewritten. In an example embodiment, the unified view overlays buffer rows over master rows using a precedence rule (e.g., for a given primary key, prefer the most recent buffer-table value; otherwise fall back to the master-table value). In some embodiments, generating the unified view includes generating a non-materialized table that represents a join and/or union of the master and buffer tables (e.g., a join on identifier), and generating a materialized table (or materialized representation) that caches at least part of that join result. The cached (materialized) representation may include frequently accessed columns, computed columns, projections, summaries, and/or join results for frequently queried subsets. This materialized table is a key mechanism for minimizing repeated computation and minimizing the need to physically rewrite the master table on every incoming change.

At step 808, the database platform may query on the materialized table of the unified view to retrieve one or more identity records having updated data. In various embodiments, step 808 includes receiving one or more queries from one or more client devices and executing those queries against the unified view by leveraging the materialized table (e.g., instead of scanning both the master table and the external table and joining them on the fly). In some embodiments, the result of step 808 includes identifiers and/or rows for which the buffer table contains updated values, and those identifiers may be returned to clients (e.g., for near-real-time workflows) and/or used internally to scope later merge activity. As one example, a client workflow may request “all identifiers whose event attributes changed in the last five minutes.” Rather than rewriting the master table for every event, the database platform answers the query by reading from the unified view’s materialized table, which already caches the combined result needed for the query. As another example, the database platform may compute (and optionally persist) a set of identity records that have been updated, and later use that set to selectively merge only those affected identifiers (or partitions containing those identifiers) into the master table.

At step 810, the database platform may generate metadata related to at least one of the unified view and the buffer table. In various embodiments, the metadata includes one or more size measurements and/or one or more performance metrics. Non-limiting examples of size measurements include: number of rows in the buffer table; number of bytes in the buffer table; number of unique identifiers represented in the buffer table; a relative-size metric such as “buffer-table rows as a percentage of master-table rows”; number of affected partitions/micro-partitions; and/or a size of the unified view or its materialized table. Non-limiting examples of performance metrics include: query runtime for one or more queries executed on the unified view; response time observed by clients; CPU and/or memory consumption associated with maintaining or querying the unified view; cache hit rate for the materialized table; and/or a unified-view degradation level that quantifies performance degradation as the buffer table grows. In some embodiments, the metadata is refreshed incrementally as new changed data is inserted into the buffer table and/or as the materialized table is updated.

At step 812, the merge optimization system may compare one or more pieces of the metadata to one or more merge conditions. In various embodiments, merge conditions are configurable policies that specify when to physically merge buffered changes into the master table, and the merge conditions may be based on (i) size-based triggers, (ii) performance-based triggers, or (iii) combinations thereof. For example, a merge condition may specify that a merge is triggered when the buffer table exceeds a threshold size (e.g., 5 GB, 10 million rows, 10% of master-table rows, and the like). A merge condition may specify that a merge is triggered when performance of the unified view degrades beyond a degradation threshold (e.g., when unified-view query response time exceeds a threshold or exceeds a baseline by a threshold amount). In some embodiments, merge conditions are tuned or adjusted based on access patterns of the master table, available merge resources, and/or configurations of the external table, buffer table, and unified view. In certain implementations, the merge conditions may include both a “merge trigger” condition and a “merge scope” condition that controls which portion of the master table will be rewritten. For instance, the merge scope may be limited to (i) the identity records identified in step 808, (ii) partitions that contain those identity records, and/or (iii) partitions that contribute disproportionately to unified-view performance degradation. Importantly, and consistent with the goal of minimizing data rewrites in merge operations and consumption of compute, network, and/or power resources associated with the rewrite operations, the merge process may be configured to use the materialized table generated based on the buffer table to provide a comprehensive dataset (e.g., the records in the master table and the updated data) instead of rewriting the entire master table as long as the performance of the unified view is sufficient.

At step 814, the merge optimization system may initiate a merge process based on identifying a piece of metadata that satisfies one or more of the merge conditions. In some embodiments, initiating the merge process includes selecting a merge strategy (e.g., rewrite-only-affected-partitions versus rewrite-a-full-new-master-table), selecting a time to run the merge (e.g., immediately or via a scheduler), and/or reserving resources (e.g., CPU, memory, I/O bandwidth) via a resource manager. Initiation may further include generating a merge plan that enumerates which identifiers, partitions, files, or segments are to be rewritten, thereby enabling a selective merge that targets only the portions of the master table implicated by the buffered changes and/or implicated by observed performance degradation.

At step 816, a resource manager connected to the merge processor may execute the merge process to update the master table by merging the changed data in the buffer table with the original data in the master table. The resource manager may use the compute resources available to the database platform to execute the merge process in an efficient manner. In various embodiments, executing the merge includes applying inserts, updates, deletes, and/or upserts so that the master table becomes an updated, durable representation of the dataset. Importantly, and consistent with the goal of minimizing data rewrites and consumption of compute, network, and/or power resources associated with the rewrite operations, the merge process may be configured to reduce write amplification by rewriting only those rows, partitions, or storage files that are affected by the buffered changes, rather than rewriting the entire master table. In one example, if the buffer table contains updates to 1% of identifiers in a master table with a billion rows, the merge process may rewrite only the affected partitions (or only the affected rows within those partitions), leaving the remaining 99% of master-table storage unchanged. In some embodiments, the merge process further includes updating metadata and/or refreshing the unified view’s materialized table (or rebuilding a portion thereof) to reflect that buffered changes are now incorporated into the master table, thereby restoring unified-view performance and reducing future degradation.

At step 818, the database platform may clear the changed data from the buffer table. In some embodiments, clearing includes truncating the buffer table, deleting merged delta files, marking records as merged, and/or generating a new empty buffer table for subsequent updates. Clearing may also include resetting or updating metadata associated with the buffer table and unified view so that merge conditions are evaluated against current (post-merge) state. After clearing, new changed data from the external table may be inserted into the empty buffer table, thereby restarting the optimized merge process and enabling continued near-real-time queryability via the unified view without forcing immediate rewrites of the large master table.

In various embodiments, process 800 is repeated continuously or periodically. For example, steps 802–808 may run frequently to keep the unified view current and queryable as new changes arrive, while steps 810–818 may occur only when merge conditions are satisfied (e.g., when unified-view performance degradation exceeds a threshold or when the buffer table grows beyond a configured size). Accordingly, the database platform achieves both (i) near-real-time access to updated data through the unified view and its materialized table, and (ii) efficient physical consolidation into the master table through selective, condition-driven merges that minimize unnecessary table rewrites.

In this disclosure, the following definitions may apply in context. A “Client Device” or “Electronic Device” refers to any machine that interfaces to a communications network to obtain resources from one or more server systems or other client devices. A client device may be, but is not limited to, a mobile phone, desktop computer, laptop, portable digital assistant (PDA), smart phone, tablet, ultra-book, netbook, laptop, multi-processor system, microprocessor-based or programmable consumer electronic system, game console, set-top box, or any other communication device that a user may use to access a network.

“Communications Network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and coupling may be a Code Division Multiple Access (CDMA) connection, a Global System for Mobile communications (GSM) connection, or another type of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

“Component” (also referred to as a “module”) refers to a device, physical entity, or logic having boundaries defined by function or subroutine calls, branch points, application programming interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors.

It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instant in time. For example, where a hardware component includes a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instant of time and to constitute a different hardware component at a different instant of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“Image data” in this context refers to any type of visual media or other data that includes a number of rows and columns or pixels including, for example, images, frames of video, three dimensional holograms, pixel data, virtual reality (VR) content, augmented reality (AR) content, mixed reality (MR) content, extended reality (XR) content, and the like.

“Machine-Readable Medium” in this context refers to a component, device, or other tangible medium able to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EPROM)), and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“Processor” refers to any circuit or virtual circuit (a physical circuit emulated by logic executing on an actual processor) that manipulates data values according to control signals (e.g., “commands,” “op codes,” “machine code,” etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), or any combination thereof. A processor may further be a multi-core processor having two or more independent processors (sometimes referred to as “cores”) that may execute instructions contemporaneously.

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

Although the subject matter has been described with reference to specific example embodiments, it will be evident that various modifications and changes may be made to these embodiments without departing from the broader spirit and scope of the disclosed subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Description, therefore, is not to be taken in a limiting sense, and the scope of various embodiments is defined only by any appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
one or more processors; and
a memory storing instructions that, when executed by at least one processor in the one or more processors, cause the at least one processor to perform operations for generating a text response corresponding to an object displayed in a user interface (UI) page, the operations comprising:
accessing an external table including changed data associated with a master table;
inserting one or more rows of data included in the changed data into a buffer table;
generating a unified view that combines the changed data in the buffer table and original data in the master table, the unified view including a materialized table that cachesa join result of one or more rows of the master table and one or more rows of the buffer table, the unified view configured to enable one or more devices to run one or more queries on the materialized table;
querying on the materialized table of the unified view to retrieve one or more identity records having one or more pieces of the changed data;
re-accessing the external table to identify a new piece of changed data associated with the master table;
dynamically updating the buffer table by appending the new piece of changed data the buffer table; and
dynamically updating the unified view based on the updated buffer table to include the new piece of changed data in the unified view.

2. The system of claim 1, wherein the operations further comprise adjusting a merge condition based on at least one of an access pattern of the master table, available merge resources, a configuration of the external table, a configuration of the buffer table, and a configuration of the unified view.

3. The system of claim 1, wherein the operations further comprise adjusting a merge condition based on a size measurement for the external table, a size measurement for the unified view, and a size measurement for the buffer table.

4. The system of claim 1, wherein the operations further comprise adjusting a merge condition based on a performance metric, a degradation threshold for the unified view, and a query response time for the unified view.

5. The system of claim 1, wherein the operations further comprise querying on the external table to identify one or more pieces of the changed data from the external data in the external table.

6. The system of claim 1, wherein the one or more queries generate query results that identity one or more identity records in the original data that have changed data.

7. The system of claim 1, wherein generating the unified view comprises generating a first non-materialized table that includes the changed data in the buffer table and the original data the master table; and
generating a materialized version of the first-non materialized table that includes one or more rows of the changed data and one or more rows of the master table.

8. The system of claim 1, wherein the operations further comprise generating metadata related to at least one of the unified view and the buffer table;
comparing one or more pieces of the metadata to one or more merge conditions;
initiating a merge process based on identifying a piece of metadata that satisfies one or more of the merge conditions;
executing the merge process to update the mater table by merging the changed data in the buffer table with the original data in the master table; and
clearing the changed data from the buffer table.

9. The system of claim 8, wherein the one or more merge conditions include a master size metric and a relative size metric and the operations further comprise:
determining a master size metric for the master table;
determining a relative size for the buffer table based on a comparison of the buffer size metric and the master size metric; and
executing the merge process based on a comparison of the relative size metric to a merge condition.

10. The system of claim 1, wherein the one or more merge conditions includes a degradation level of the buffer view and a buffer size of the buffer table.

11. A method for generating a text response corresponding to an object displayed in a user interface (UI) page, the method comprising:
accessing an external table including changed data associated with a master table;
inserting one or more rows of data included in the changed data into a buffer table;
generating a unified view that combines the changed data in the buffer table and original data in the master table, the unified view including a materialized table that cachesa join result of one or more rows of the master table and one or more rows of the buffer table, the unified view configured to enable one or more devices to run one or more queries on the materialized table;
querying on the materialized table of the unified view to retrieve one or more identity records having one or more pieces of the changed data;
re-accessing the external table to identify a new piece of changed data associated with the master table;
dynamically updating the buffer table by appending the new piece of changed data the buffer table; and
dynamically updating the unified view based on the updated buffer table to include the new piece of changed data in the unified view.

12. The method of claim 11, further comprising adjusting a merge condition based on at least one of an access pattern of the master table, available merge resources, a configuration of the external table, a configuration of the buffer table, and a configuration of the unified view.

13. The method of claim 11, further comprising adjusting a merge condition based on a size measurement for the external table, a size measurement for the unified view, and a size measurement for the buffer table.

14. The method of claim 11, further comprising adjusting a merge condition based on a performance metric, a degradation threshold for the unified view, and a query response time for the unified view.

15. The method of claim 11, further comprising querying on the external table to identify one or more pieces of the changed data from the external data in the external table.

16. The method of claim 11, wherein the one or more queries generate query results that identity one or more identity records in the original data that have changed data.

17. The method of claim 11, wherein generating the unified view comprises generating a first non-materialized table that includes the changed data in the buffer table and the original data the master table; and
generating a materialized version of the first-non materialized table that includes one or more rows of the changed data and one or more rows of the master table.

18. The method of claim 11, further comprising generating metadata related to at least one of the unified view and the buffer table;
comparing one or more pieces of the metadata to one or more merge conditions;
initiating a merge process based on identifying a piece of metadata that satisfies one or more of the merge conditions;
executing the merge process to update the mater table by merging the changed data in the buffer table with the original data in the master table; and
clearing the changed data from the buffer table.

19. The method of claim 18, wherein the one or more merge conditions include a master size metric and a relative size metric, the method further comprising:
determining a master size metric for the master table;
determining a relative size for the buffer table based on a comparison of the buffer size metric and the master size metric; and
executing the merge process based on a comparison of the relative size metric to a merge condition.

20. The method of claim 11, wherein the one or more merge conditions include a degradation level of the buffer view and a buffer size of the buffer table.
